(19) United States
(12) Patent Application Publication
(10) Pub. No.: US 2011/0114070 A1
(43) Pub. Date: May 19, 2011

(54) Apparatus and method for controlling swirl in a ported, two-stroke, internal combustion engine

(75) Inventors: Feng Song Liu, San Diego, CA (US); Gordon R. Rado, Oakland, CA (US); Michael H. Wahl, San Diego, CA (US); Tristan M. Burton, San Diego, CA (US)

(73) Assignee: Achates Power, Inc., San Diego, CA (US)

(21) Appl. No.: 12/927,554

(22) Filed: Nov. 17, 2010

Related U.S. Application Data
(60) Provisional application No. 61/395,845, filed on May 18, 2010.
(60) Provisional application No. 61/281,457, filed on Nov. 18, 2009.

(51) Int. Cl. F02M 29/10

(52) U.S. Cl. 123/590

(57) ABSTRACT

An apparatus and a method for controlling swirl of air in a ported, two-stroke internal combustion engine include deflecting air into the intake port of a ported cylinder by an array of vanes disposed around the cylinder's intake port. The angle of deflection establishes the swirl of air in the cylinder. Swirl is varied by changing the angular positions of the vanes under the control of a vane drive mechanism coupled to an actuator. A swirl control mechanization controls vane angular position in response to engine operating parameters.

### PRIORITY

This patent application claims priority of U.S. provisional application for patent 61/395,845, filed May 18, 2010, and U.S. provisional application for patent 61/281,457, filed Nov. 18, 2009.

### BACKGROUND

The field includes ported cylinders of internal combustion engines. More specifically the field relates to an internal combustion engine equipped with a vane apparatus to deflect air into the bore of a ported cylinder at varying angles. In particular, the field covers a cylinder having an intake port equipped with an vane apparatus to control swirl of charge air in the cylinder by moving vanes adjacent the intake port to angular positions relative to the intake port in response to engine operating conditions.

A ported internal combustion engine is an internal combustion engine having a cylinder with one or more ports through its side wall for the passage of air into and/or out of the bore of the cylinder. Relatedly, such a cylinder is a ported cylinder. For example, the ported cylinder of a two-stroke type engine has an exhaust port in a cylinder head and an intake port in the sidewall of the cylinder. In another example, an opposed-piston engine typically includes exhaust and intake ports cast, machined, or otherwise formed in the cylinder sidewall near respective exhaust and intake ends thereof. A ported cylinder can be constituted as a unitary structure, as an element of an engine structure, or as a liner (sometimes called a “sleeve”). For illustration, but not for limitation, a liner is a cylindrical part that is received in an engine block or spar to form a cylinder.

In some ported engine configurations, a single piston is disposed in a cylinder's bore and traverses an intake port while moving through a bottom dead center (BDC) position. In other two-stroke engine configurations, opposed pistons disposed crown-to-crown in a cylinder's bore traverse exhaust and intake ports during engine operation. For example, FIG. 1A illustrates an opposed-piston engine that includes at least one cylinder 10 with a bore 12 and longitudinally-displaced exhaust and intake ports 14 and 16 machined or formed therein. At least one fuel injector nozzle 17 is located in an injector port that opens through the sidewall of the cylinder, at or near the longitudinal center of the cylinder. Two pistons 20, 22 are disposed in the bore 12 with their end surfaces 20e, 22e in opposition to each other. For convenience, the piston 20 is referred as the “exhaust” piston because of its proximity to the exhaust port 14; and, the end of the cylinder wherein the exhaust port is formed is referred to as the “exhaust end”. Similarly, the piston 22 is referred as the “intake” piston because of its proximity to the intake port 16, and the corresponding end of the cylinder is the “intake end”.

Operation of an opposed-piston engine with one or more cylinders 10 is well understood. In this regard, and with reference to FIG. 1B, in response to combustion occurring between the end surfaces, the opposed pistons move away from respective top dead center (TDC) positions (also called “inner dead center positions”) where they are at their closest positions relative to one another in the cylinder. While moving from TDC, the pistons keep their associated ports closed until, as shown in FIG. 1A, they approach respective bottom dead center (BDC) positions (also called “outer dead center positions”) in which they are furthest apart from each other. Frequently, but not exclusively, a phase offset in the piston movements around their BDC positions is employed to produce a sequence in which the exhaust port 14 opens as the exhaust piston 20 moves through BDC while the intake port 16 is still closed so that exhaust gasses produced by combustion start to flow out of the exhaust port 14. As the pistons continue moving away from each other, the intake port 16 opens while the exhaust port 14 is still open and a charge of pressurized air (“charge air”) enters the intake port and flows into the cylinder 10, driving exhaust gasses out of the exhaust port 14. The displacement of exhaust gas from the cylinder through the exhaust port while admitting charge air through the intake port is referred to as “scavenging”. Because the charge air entering the cylinder flows in the same direction as the outflow of exhaust gas (toward the exhaust port), the scavenging process is referred to as “uniflow scavenging”.

Per FIG. 1A, as the exhaust port 14 closes after the pistons reverse direction, the intake port 16 remains open while the intake piston 22 continues to move away from BDC. As the pistons continue moving toward TDC (FIG. 1B), the intake port 16 is closed and the charge air in the cylinder is compressed between the end surfaces of the pistons. Typically, the charge air passes through the intake port 16 at an angle tangential to a cylinder (not shown) sharing the longitudinal axis of the cylinder 10, which causes the charge air to swirl in the cylinder 10. The primary purposes of swirl are to facilitate scavenging and air/fuel mixing. Desirably, two-stroke engine design provides for generating swirl to achieve these goals.

With reference to FIG. 1A as an example, the swirling charge air (or simply, “swirl”) 30 has a generally helical motion in the bore which circulates around the longitudinal axis of the cylinder with an angular velocity. As best seen in FIG. 1B, as the pistons advance toward their respective TDC locations in the cylinder bore, fuel 40 is injected by the one or more nozzles 17, through the cylinder sidewall, directly into the swirling charge air 30 in the bore 12 (“direct side injection”), between the end surfaces 20e, 22e of the pistons. The movement of the fuel interacts with the residual vortical motion of the charge air in the bore to mix the air and fuel in preparation for combustion. The swirling mixture of charge air and fuel is compressed in a combustion chamber 32 defined between the piston end surfaces 20e and 22e when the pistons 20 and 22 are near their respective TDC locations. When the fuel ignites, the pistons are driven apart toward their respective BDC locations.

Referring to FIG. 1C, the intake port is constituted of a ring or annulus of port openings 35 centered on the longitudinal axis 37 of the cylinder 10. In the ring, each port opening 35 is separated from a neighbor by a slanted bridge 38. The slanted bridges define a port opening slant. A port opening slant corresponds to an angle that a port opening axis 39 makes with a radius 41 of the cylinder that intersects the port opening. As seen in FIG. 1C, a port opening slant can define a slant angle that deviates substantially from the radial direction of the bore. The port opening slant causes charge air to enter the cylinder bore at the slant angle; the slant angle causes the charge air to swirl in the bore.

The prior art teaches generation of swirl with fixed characteristics by means of slanted intake port openings that generate the helical motion of air in the cylinder bore. For example, Gerlach's U.S. Pat. No. 2,170,020 teaches that the slanted wall shapes are fixed and cannot be varied. In order to vary swirl in a fixed manner, axially-spaced, circular sequences of intake port openings are formed with different slant angles so as to reduce centrifuging effects of swirl. In another example, GB patent 494,869 teaches the provision of different wall slant angles in a single ring of intake port openings. These solutions utilized fixed ramped port surfaces to deflect air entering the intake port. Because the ramp angles are fixed, the swirl cannot be varied in response to changes in engine operating conditions.

However, it is desirable that measures be provided to continuously and dynamically vary swirl in response to changes in engine operating conditions. In this regard, it is desirable to vary the angular velocity of swirl, and thereby the intensity of the swirl motion, in response to changes in engine operating conditions. In some circumstances, it is even desirable to modify in-cylinder swirl from one period to another of a single operating cycle. For given engine speed and load conditions it is desirable to adjust swirl in order to optimize scavenging, air/fuel mixing, and/or combustion to meet the demands of engine performance.

Variable control of the velocity of charge air moving into the cylinder bore is taught in Colburn's U.S. Pat. No. 2,160,380. In this regard, a sleeve with a moveable shutter mechanism mounted thereto is received over the intake port of the cylinder of an opposed-piston engine. The sleeve has apertures that are aligned with, and angled correspondingly to, the intake port openings, thereby lengthening each angled charge air passageway into the intake end of a cylinder. The shutter mechanism rotates shutter members on hinges to open and close the angled apertures in the sleeve. The effect of shutter member movement is to vary the velocity of charge air entering each angled passageway. According to Colburn, the desirable result of charge air velocity control is the ability to control the times at which charge air reaches the exhaust port at different engine speeds so as to maintain complete scavenging at differing engine speeds. The size of the shutter mechanism sleeve and the pivot radius of the shutter members add to the effective diameter of the cylinder at the intake port, thereby effectively increasing the inter-cylinder spacing and the size of the engine.

A laboratory study of a variable swirl-inducing device for two-stroke engine is described in Packer J P Barrishi A Y and Zujing S, The Application of a Variable Swirl-inducing Device to a Two-stroke, Engine of 200 mm Bore, SAE Technical Paper Series 861306, Sep. 11, 1986, 1986. The variable swirl-inducing device was designed to facilitate the air inflow for the intake port in a cylinder of Petters' well-known single-piston, two-stroke cylinder configuration. In the cylinder, an intake port is located near bottom dead center (BDC) of piston movement and an exhaust valve is mounted in a cylinder head so as to be located near top dead center (TDC) of the piston's movement. Moveable vanes are mounted to extend into the passageways of the intake port so as to divert the air flow direction and encourage a swirl in the cylinder back into the exhaust valve. Each vane is moveable to one of four positions; at each position, the vane defines a particular angle within an intake port opening, and incoming air is deflected into the port at the angle. The differing angles create differing conditions of in-cylinder swirl. However, the air/fuel mixing conditions of this disclosure are limited to injection of fuel through the cylinder head, along the swirl axis, which avoids the air/fuel asymmetry resulting from direct side injection as would be found in opposed-piston engines. Furthermore, no description is given of a mechanism or a method for controlling movement of the vanes in any two-stroke configuration as would be necessary to incorporate a variable swirl device into the construction of a ported internal combustion engine.

Accordingly, there is a need in ported internal combustion engines for an apparatus that operates automatically in response to engine operating conditions to vary an angle at which air enters the intake port of a ported cylinder in order to control swirl in the cylinder.

Further, there is a need in ported internal combustion engines for a method of engine operation in which an angle at which air entering the intake port of a ported cylinder is automatically varied in response to engine operating conditions in order to control swirl in the cylinder.

### SUMMARY

An object of this invention is to provide for continuous control of swirl in a ported cylinder so as to support scavenging and/or fuel/air mixing under varying engine operating conditions. Desirably, a vane apparatus varies the angle at which the air is conducted through an intake port in order to control at least the angular velocity with which the air swirls in a cylinder.

In the invention described hereinafter, a ported cylinder is equipped with a vane apparatus constituted of a set of moveable vanes disposed at the cylinder intake port to control an angle at which air is conducted through the intake port. The angle of the incoming air is varied by changing the angular dispositions of the vanes relative to the intake port under the control of a vane drive mechanism.

In the invention described hereinafter, a ported cylinder is equipped with a vane apparatus in which a set of pivoted vanes abutting the intake port of the cylinder controls an angle at which charge air swirls in the cylinder. The swirl angle is varied by changing the angular positions of the vanes relative to the intake port under the control of a vane drive mechanism.

Another object of this invention is to provide a control mechanization that controls swirl in a two-stroke engine with one or more ported cylinders.

In the invention described herein, a method of operating a vane apparatus in a ported, two-stroke internal combustion engine includes controlling in-cylinder swirl in response to varying engine load conditions.

In the invention described herein, a swirl control mechanization controls swirl in response to engine operating parameters.

### BRIEF DESCRIPTION OF THE DRAWINGS

The below-described drawings are meant to illustrate principles and examples discussed in the following description. They are not necessarily to scale.

FIG. 1A is a partially schematic, longitudinal sectional drawing of a cylinder of a prior art opposed-piston engine with opposed pistons near respective bottom dead center locations, and is appropriately labeled “Prior Art”. FIG. 1B is a side sectional partially schematic drawing of the cylinder of FIG. 1A with the opposed pistons near respective top dead center locations where end surfaces of the pistons define a combustion chamber, and is appropriately labeled “Prior Art”. FIG. 1C is a cross-section of the cylinder showing a ring of port openings and bridges that constitute an intake port of the cylinder, and is appropriately labeled “Prior Art”.

FIG. 2 is a conceptual schematic diagram of an internal combustion engine in which aspects of the invention are illustrated.

FIG. 3A-3C is an explanatory sequence diagram illustrating a ported, uniflow-scavenging cylinder equipped with a preferred vane apparatus construction to control swirl in the cylinder.

FIG. 4A is an exploded perspective view of the intake end of the cylinder of FIGS. 3A-3C showing elements of the preferred vane apparatus construction and the intake port. FIG. 4B is a sectional view of the intake end with the preferred vane apparatus construction assembled thereto. FIG. 4C is a magnified view showing construction details circumscribed by the dotted circle in FIG. 4B. FIG. 4D is a perspective view of the intake end with the preferred vane apparatus construction assembled thereon.

FIG. 5 is a view into the intake plenum of a ported, multi-cylinder, internal combustion engine with the preferred vane apparatus construction mounted to the intake ends of a plurality of ported cylinders.

FIG. 6A-6C is an explanatory sequence diagram illustrating a ported, uniflow-scavenging cylinder equipped with a second vane apparatus construction to control swirl in the cylinder.

FIG. 7A is a sectional view of the intake end of the cylinder of FIGS. 6A-6C showing the second vane apparatus construction at the intake port. FIG. 7B is an exploded perspective view of the end of the cylinder of FIG. 7A. FIG. 7C is an assembled perspective view of the end of the cylinder of FIG. 7A.

FIG. 8 is a view into the intake plenum of a ported, multi-cylinder, internal combustion engine with the second vane apparatus construction mounted to the intake ends of a plurality of ported cylinders.

FIG. 9 is a view into the intake plenum of a partially-assembled opposed-piston engine with an intake plenum cover removed to show a third vane apparatus construction.

FIG. 10A is a sectional view of the partially-assembled engine taken along the plane A-A in FIG. 9. FIG. 10B is an enlarged view of two of the four cylinders seen in FIG. 10A showing elements of the third vane apparatus construction.

FIG. 11 is a three-dimensional-view of elements of the third vane apparatus construction for a cylinder of a multi-cylinder ported engine.

FIG. 12 is a flow diagram depicting a control mechanization for setting intake vane angles in response to engine load conditions.

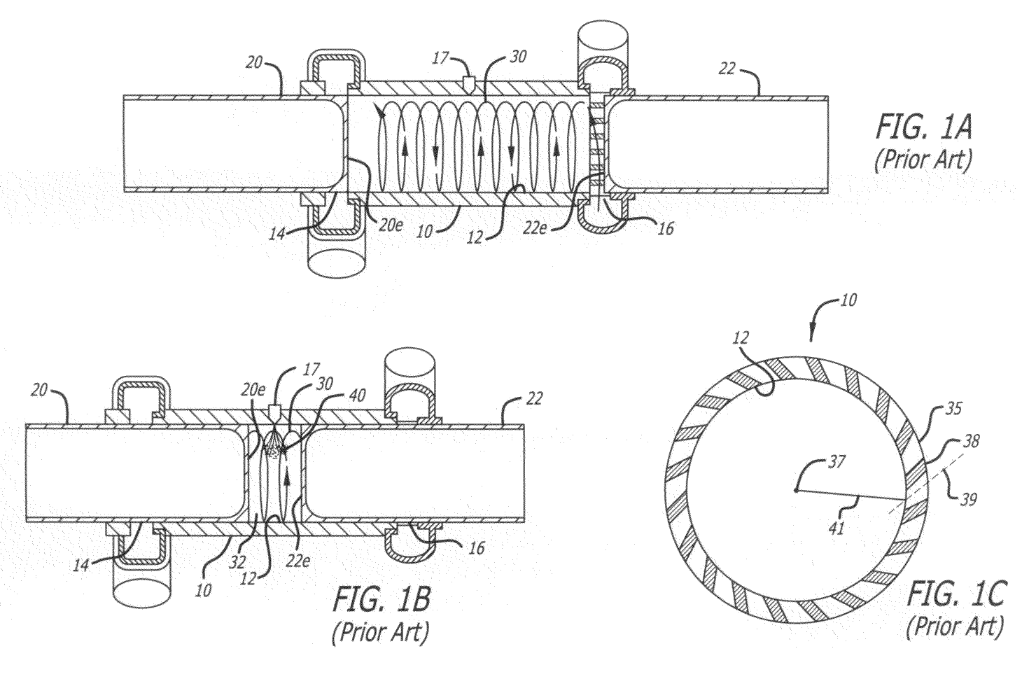

### DETAILED DESCRIPTION OF THE PREFERRED CONSTRUCTIONS

A vane apparatus that varies intake vane angles to control swirl in a ported internal combustion engine is illustrated in one or more of the above-described drawings, and is disclosed in detail in the following description. Although various vane apparatus constructions are described with respect to particular two-stroke, compression-ignition engine constructions, it should be noted that the drawings and the accompanying description merely provide useful illustrations of constructions and operations of the invention, but are not intended to limit the scope of its application.

Motion characteristics of airflow into the intake port of a ported cylinder are varied in order to adjust swirl in response to varying operating conditions of two-stroke, internal combustion engines. Desirably, adjusting swirl maintains effective scavenging and good fuel/air mixing under varying engine load conditions. Representative constructions for adjusting at least the angle at which air enters a cylinder through an intake port in a sidewall of the cylinder include a vane apparatus that varies an angle at which air enters the intake port and thus adjusts the angular velocity at which the charge air swirls in the cylinder. Various vane angling constructions include an annular array of moveable vanes mounted to the cylinder in an abutting relationship with the cylinder intake port. In response to movement of an actuator in driving engagement with the array, the vanes swing to angular positions relative to the intake port openings. The array of vanes can be set to a first angle that establishes a first swirl condition and then to another angle that establishes a second swirl condition. Preferably, movement of the vanes is continuous so as to afford the ability to continuously vary swirl. Nevertheless, in some aspects vane movement can be step-wise.

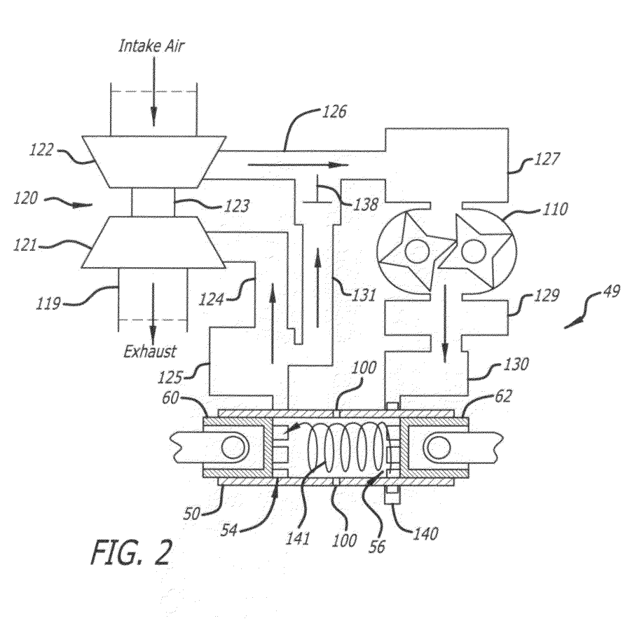

In FIG. 2, an internal combustion engine 49 is embodied by an opposed-piston engine having one or more cylinders 50. For example, the engine may have one cylinder, two cylinders, or three or more cylinders. Each cylinder 50 has exhaust and intake ports 54 and 56 formed or machined in respective ends of the cylinder. Each of the exhaust and intake ports 54 and 56 includes at least one ring of openings in a circumferential direction of the cylinder in which adjacent openings of any ring are separated by a solid bridge. (In some descriptions, each opening of such a ring is referred to as a “port”; however, the construction of a circumferential sequence of such “ports” is no different than the port constructions shown in FIG. 2.) Exhaust and intake pistons 60 and 62 are slidably disposed in the cylinder bore with their end surfaces opposing one another. Fuel is injected directly into the combustion chamber, between the piston end surfaces, through at least one fuel injector nozzle 100 positioned in an opening through the side of the cylinder 50. Preferably, but not necessarily, fuel is injected through a pair of opposed fuel injector nozzles.

In FIG. 2, an air charge system manages charge air provided to, and exhaust gas produced by, the engine 49. The air charge system construction includes a charge air source that compresses fresh air (or a mixture of fresh air and recirculated exhaust gasses) and a charge air channel through which charge air is transported to the at least one intake port 56 of the engine. The air charge system construction also includes an exhaust channel through which the products of combustion (exhaust gasses) are transported from the at least one exhaust port, processed, and released into the atmosphere. The air charge system includes an exhaust manifold 125. A turbo-charger 120 extracts energy from exhaust gas that exits the exhaust ports 54 and flows into a conduit 124 from the exhaust manifold 125. The turbo-charger 120 includes a turbine 121 and a compressor 122 that rotate on a common shaft 123. The turbo-charger 120 can be a single-geometry or a variable-geometry device. The turbine 121 is rotated by exhaust gas passing through it to an exhaust output 119. This rotates the compressor 122, causing it to compress fresh air obtained through an air input. The charge air output by the compressor 122 flows through a conduit 126 to a charge air cooler 127, and from there to a supercharger 110 where it is further compressed. The supercharger 110 is coupled by a belt linkage to a crankshaft (not shown) so as to be driven thereby. The supercharger 110 can be a single-speed or multiple-speed device or a fully variable-speed device. Air compressed by the supercharger 110 is output from the supercharger through a charge air cooler 129 to an intake manifold 130. One or more intake ports 56 receive a charge of air pressurized by the supercharger 110 through the intake manifold 130. Preferably, but not necessarily, in multi-cylinder opposed-piston engines, the intake manifold 130 is constituted of an intake plenum that communicates with the intake ports 56 of all cylinders 50. Preferably, but not necessarily, the air charge system of the engine in FIG. 2 includes an exhaust gas recirculation (EGR) channel that extracts exhaust gasses from the exhaust channel and processes and transports the extracted exhaust gasses into the incoming stream of fresh intake air by way of a valve-controlled recirculation channel 131 controlled by an EGR valve 138. The intake port 56 of a cylinder 50 is equipped with a vane apparatus 140 that adjusts the angle at which pressurized air (charge air, for example) flows through the intake port 56, which in turn adjusts the swirl 141 in the cylinder 50. Desirably, the vane apparatus mounts directly to an intake port of a cylinder, with no intermediate structures between the vane apparatus and the intake port; in some aspects, the vanes of the vane apparatus are directly mounted to the intake port.

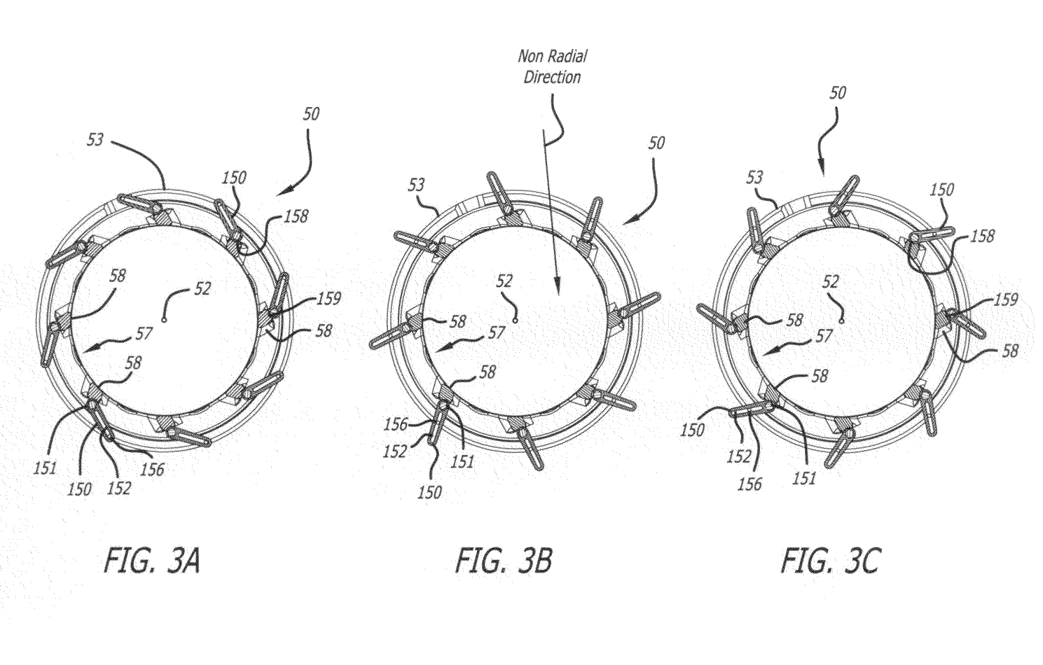

Preferred intake vane apparatus construction: With reference to FIGS. 3A-3C, the cylinder 50 has a sidewall with an outer surface 53, a longitudinal axis 52, and an intake port that includes a ring of port openings 57 separated by bridges 58. Preferably, side surfaces of the bridges 58 are ramped at an angle that is tangential relative to the longitudinal axis of the cylinder 50 so as to orient the axis of each port opening 57 in a non-radial direction of the cylinder. In some aspects, the bridges 58 are recessed into the sidewall of the cylinder 50, inwardly of the outer surface 53. In a preferred construction of the vane apparatus 140, a ring of pivoted vanes 150 is retained in an abutting angular relationship with the intake port. Each vane pivots on a pivot pin 151; and each vane 150 has an elongated upper edge through which a narrow elongated slot 152 opens into the vane. An intake vane drive assembly (not seen in this view) is disposed on the outside surface of the cylinder 50 and is rotatable thereon in opposing circumferential directions of the cylinder. Pins 156 on the actuating ring drivingly engage the slots 152 of the vanes. As the actuating ring is rotated clockwise relative to the orientation of the vanes shown in FIG. 3A to swing the vanes in a clockwise direction to the position shown in FIG. 3B, the pins 156 slide in the slots 152, causing the vanes 150 to pivot from a first angular position shown in FIG. 3A to a second position shown in FIG. 3B (or to any position therebetween).

As the actuating ring is rotated clockwise relative to the vane orientation shown in FIG. 3B, the pins 156 slide in the slots 152, causing the vanes 150 to swing from the second angular position to a third angular position shown in FIG. 3C (or to any position therebetween). The rotating motion of the actuating ring is bi-directional, and the vanes are swung in either a clockwise or a counter-clockwise direction in response to rotation of the actuating ring to any position between (and including) the two extreme positions seen in FIGS. 3A and 3C.

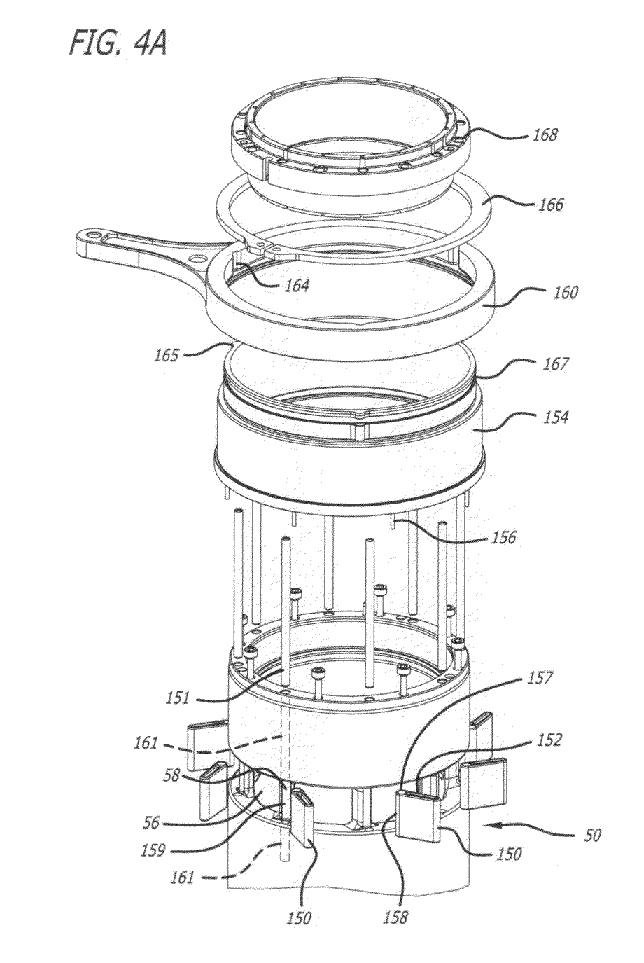

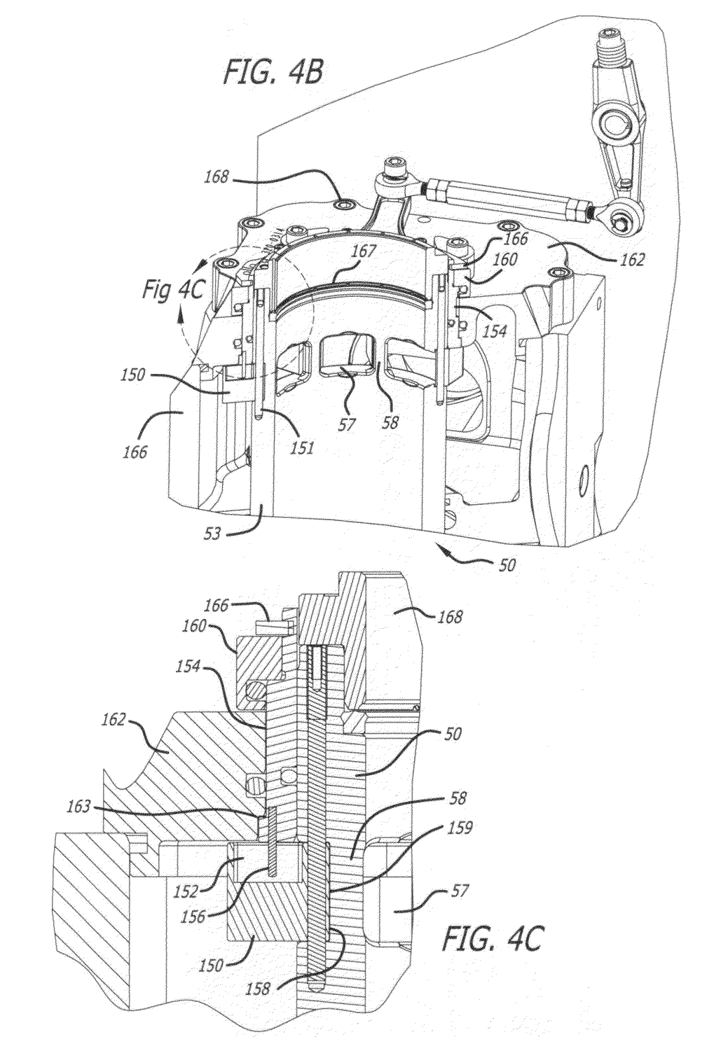

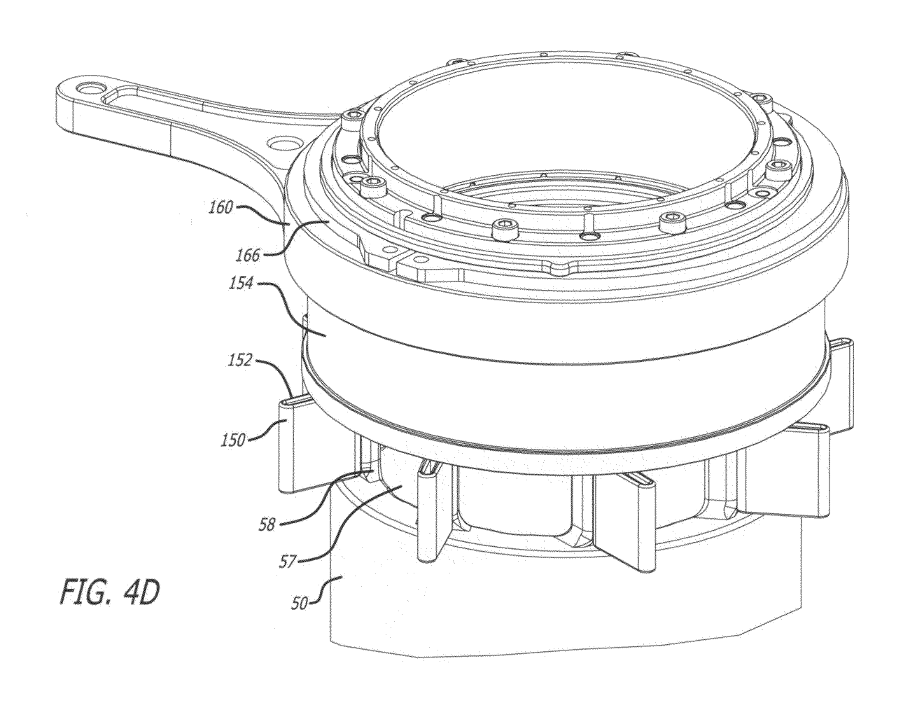

As per FIGS. 4A-4D, a vane drive assembly for continuously varying the angle of the vanes 150 at the intake port 56 of the cylinder 50 includes an actuating ring 154 and a drive ring 160 with pins 156 seated therein and extending therefrom, and a driving ring 160 received on and locked to the actuating ring 154. In addition to a slot 152, each vane 150 includes a hinge passageway 157 near a rounded side edge 158 of the vane. Each bridge 58 has a longitudinal, half-pipe groove 159 on its outer edge that receives a rounded side edge 158 of a vane 150. Each bridge groove 159 is aligned with collinear passageways 161 drilled longitudinally in the cylinder sidewall. Each vane 150 is retained in an abutting relationship with a respective bridge by a pivot pin 151 seated in the collinear passageways 161 of the groove and extending through a hinge passageway 157 in the side edge 158 of the vane.

As per FIGS. 4B and 4C, the rounded vane side edges 158 are received in the half-pipe grooves 159 and the pivot pins 151 are inserted through the collinear passageways 161 (best seen in FIG. 4A) and vane hinge passageways 157 (best seen in FIG. 4A). The actuating ring 154 is received on the intake end of the cylinder 50 with the pins 156 received in the vane slots 152. An intake plenum cover 162 has an annular groove 163 that retains the actuating ring 154 for rotation on the intake end of the cylinder 50. The driving ring 160 is received over the upper end of the actuating ring 154. The actuating and drive rings are locked together by spline-lobe connections (best seen in FIG. 4A) and a retaining ring 166 received in a circumferential groove 167 of the actuating ring 154. An end cap 168 fixed to the rim of the intake end retains an oil scraper ring in a circumferential groove in the bore surface of the cylinder 50.

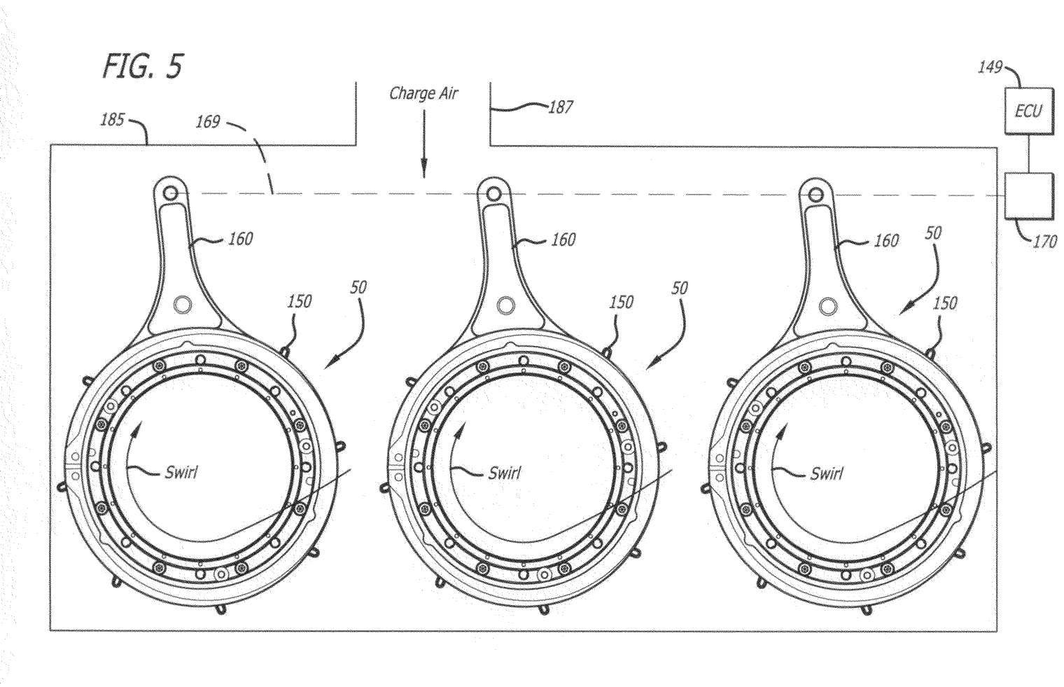

Continuously-variable intake vane angling during engine operation is illustrated in FIG. 5. Presuming that an internal combustion engine includes three cylinders 50, the elements of the engine are arranged so that the intake ports are positioned in an intake plenum 185. Pressurized air enters the plenum 185 through a conduit 187 and flows in the plenum to the intake ports. The vanes 150 are pivoted to control the angle at which charge air enters the intake ports. Vane angles are changed by movement of the driving rings 160. The driving rings 160 are connected to a common linkage 169 to be driven by a computer-controlled actuating device (“actuator”) 170 such as a stepper motor, under control of an ECU 149. Alternatively, the driving rings 160 are separately actuated so as to enable independent operation of the vanes 150 of each cylinder 50.

As per FIGS. 3A-3C and 5, the port openings are constructed to be directed in a tangential direction relative to a cylinder centered on the longitudinal axis 52, and their effect on air motion is reinforced or diminished by the angular positions of the vanes 150, especially as the thickness of the bridges 58 is reduced. Thus, in the preferred construction, the angle at which air enters the cylinder is determined principally by the angular positions of the vanes 150.

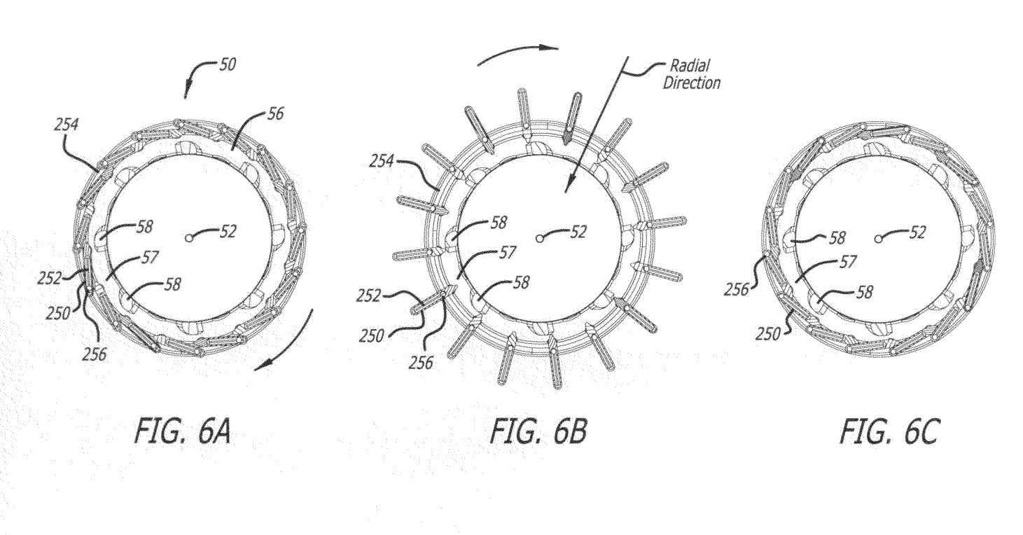

Second vane apparatus construction: With reference to FIGS. 6A-6C, the port openings 57 are formed so as to open in a radial direction of the cylinder 50. In a second construction of the vane apparatus 140, a ring of moveable vanes 250 is mounted to the outside surface of the cylinder 50, adjacent the intake port. Each vane has an upper edge through which a narrow elongated slot 252 is formed. An actuating ring 254 is disposed on the outside surface of the cylinder 50 and is rotatable thereon in opposing circumferential directions of the cylinder. Pins 256 on the actuating ring 254 drivingly engage the slots 252 of the vanes. As the actuating ring 254 is rotated clockwise from the position shown in FIG. 6A to the position shown in FIG. 6B, the pins 256 slide in the slots 252, causing the vanes 250 to pivot 90° from a first fully closed position to a fully open position (or to any position therebetween). As the actuating ring 254 is rotated clockwise from the position shown in FIG. 6B to the position shown in FIG. 6C, the pins 256 slide in the slots 252, causing the vanes 250 to pivot an additional 90° from the fully open position to a second fully closed position (or to any position therebetween). The rotating motion of the actuating ring is bi-directional, and so the vanes are pivoted in either a clockwise or a counter-clockwise direction in response to rotation of the actuating ring to any position between (and including) the two fully closed positions. In either fully closed position, the vanes cover the intake port openings, blocking the flow of air therethrough; in the fully open position, the intake port openings are unblocked, permitting the pressurized air to enter the port openings in a direction radial to the cylinder. In other words, the actuating mechanism for moving the vanes 250 causes the vanes to be swung to any angle in an arc of 180° with respect to the intake port openings, thereby enabling continuous variation of the angle at which pressurized air enters the cylinder and continuous variation of the aperture size at each port opening. From another aspect, the vanes are settable to selected angles with respect to the intake port; more particularly, the vanes are selectably set at an angle with respect to the port openings.

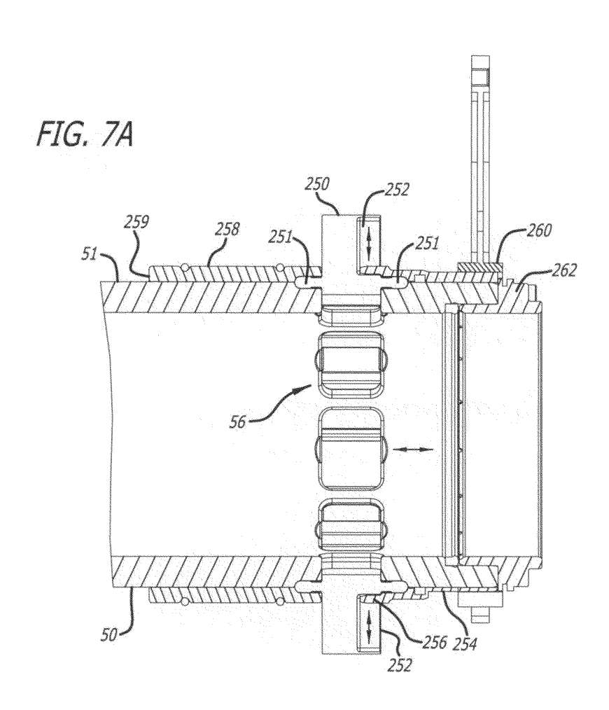

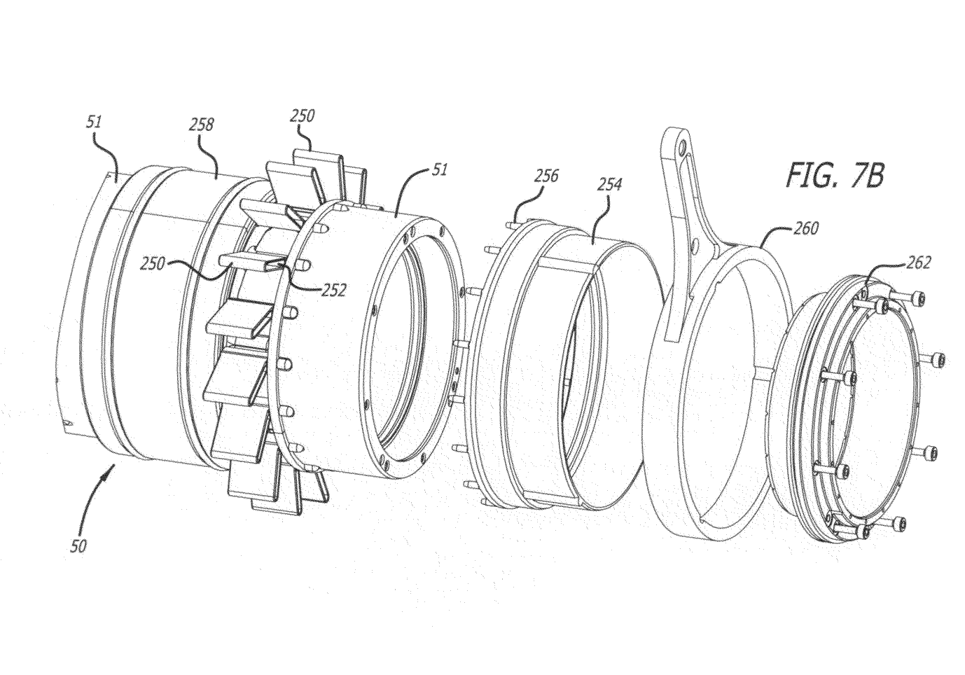

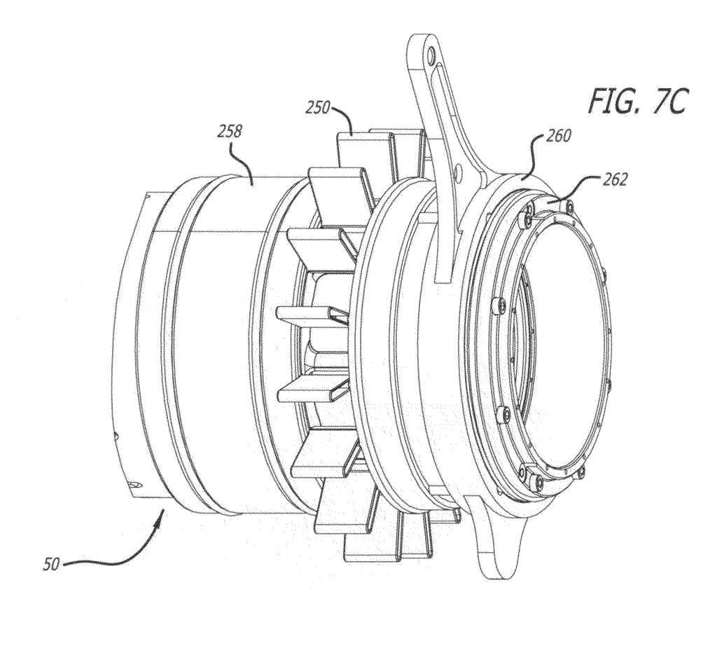

As per FIGS. 7A-7C, a vane drive assembly for continuously varying the angle of vanes at the intake port 56 of the cylinder 50 includes a retaining ring 258 disposed on the outside surface 51 of the cylinder 50, inboard of the intake port 56, an actuating ring 254 with pins 256 extending therefrom, and a driving ring 260 received on the actuating ring 254. In addition to a slot 252, each vane 250 includes oppositely-directed pins 251. Cylindrical recesses formed in the inner cylindrical surface of the retaining ring 258 receive vane pins 251 on one side of the vanes 250, and cylindrical trenches formed in the outside surface 51 of the cylinder 50 receive vane pins 251 on the other side of the vanes 250. The rear annular face 259 of the retaining ring 258 is seated against an engine structural member, such as a housing (not shown). The driving ring 260 is fitted to the outside surface of the actuating ring 254, preferably by a spline or lobe connection. The actuating ring 254 is rotatably mounted on the cylinder outer surface 51, with the actuating pins 256 received in the vane slots 252. The actuating ring 254 and the driving ring 260 are retained on the cylinder outer surface 51 by an annular end piece 262 that is detachably mounted to the intake end surface of the cylinder 50. The vanes 250 swing or pivot bi-directionally on the vane pins 251 in response to movement of the actuating ring pins 256 in the vane slots 252 as the actuating ring 254 is rotated in either direction. With reference to FIG. 7A, movement of the actuating ring pins 256 is indicated by the arrows in the vane slots 252.

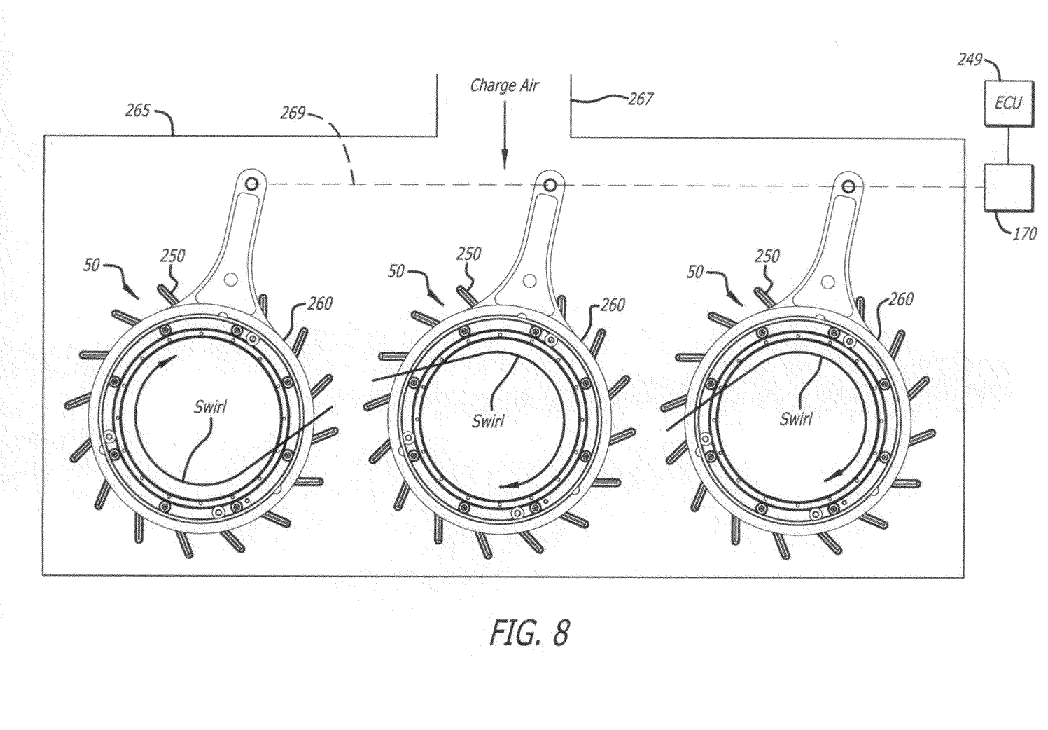

Continuously-variable intake vane angling during engine operation is illustrated in FIG. 8. Presuming that an internal combustion engine according to FIG. 2 includes three cylinders 50, the elements of the engine are arranged so that the intake ports are positioned in an intake plenum 265. Pressurized air enters the plenum 265 through a conduit 267 and flows in the plenum to the intake ports. The vanes 250 are pivoted to control the motion and quantity of pressurized air entering the intake ports. Vane angles are changed by movement of the driving rings 260. The driving rings 260 are connected to a common linkage 269 to be driven by a computer-controlled actuator 170, such as a stepper motor, under control of the ECU 149. Or, the driving rings 260 can be separately actuated so as to enable independent operation of the vanes 250 of each cylinder 50.

Since the port openings are constructed to be directed in a radial direction of a cylinder, their effect on air motion is minimal, especially as the thickness of the bridges is reduced. Thus, the motion characteristics of air entering the cylinder (including volume, angle, and direction) are determined principally by the vanes 250. With reference to FIGS. 6A and 6C, when the vanes are fully closed, little or no charge air enters the cylinder. At the fully open position of the vanes 250 shown in FIG. 6B, air enters the cylinder in a radial direction of the cylinder. As the position of the vanes 250 is varied to points between fully open and fully closed (see FIGS. 6A and 6B, for example), the direction of air entering the cylinder becomes tangential with respect to a cylinder centered on the longitudinal axis 52, which causes the air to swirl. As the position of the vanes as per FIG. 8, the circulation of the air can be varied at least in direction and velocity, in response to engine conditions.

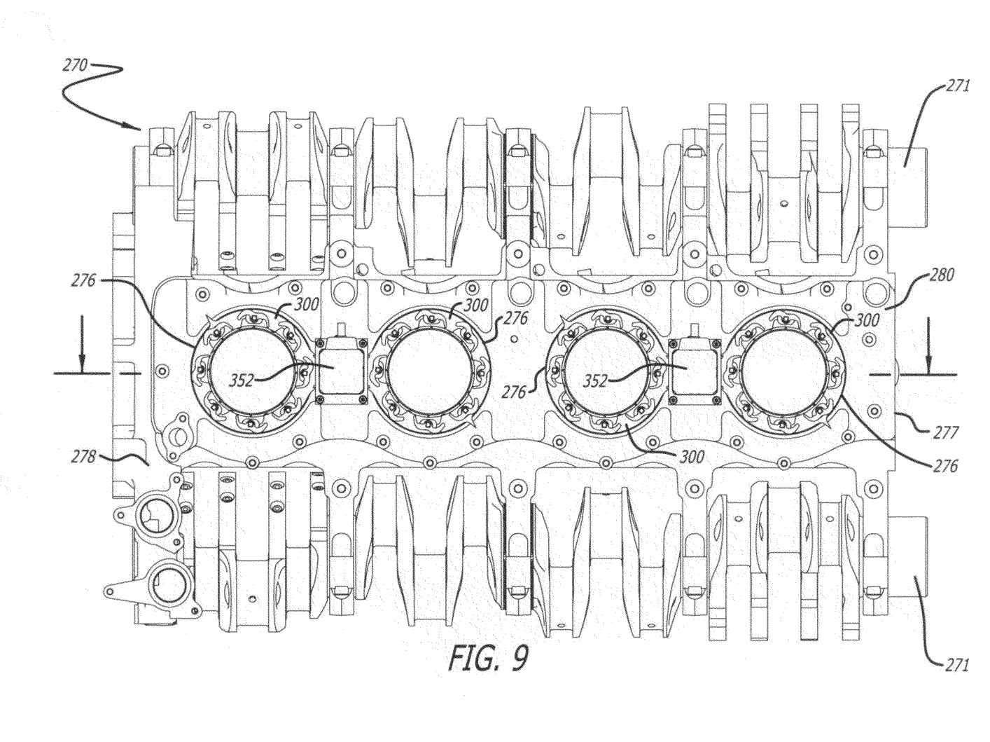

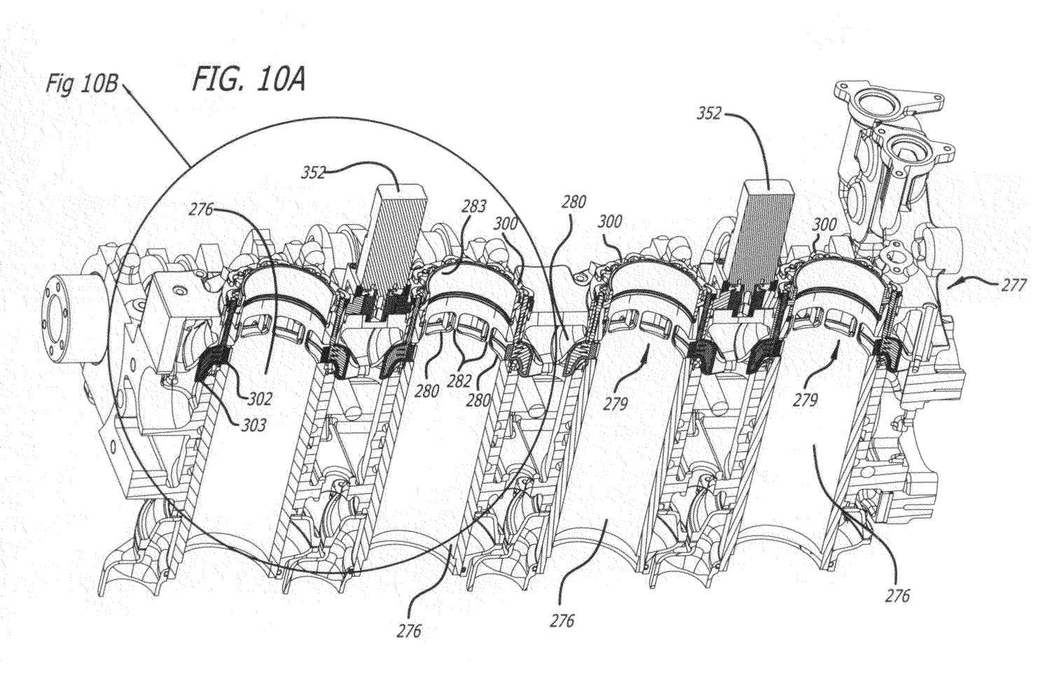

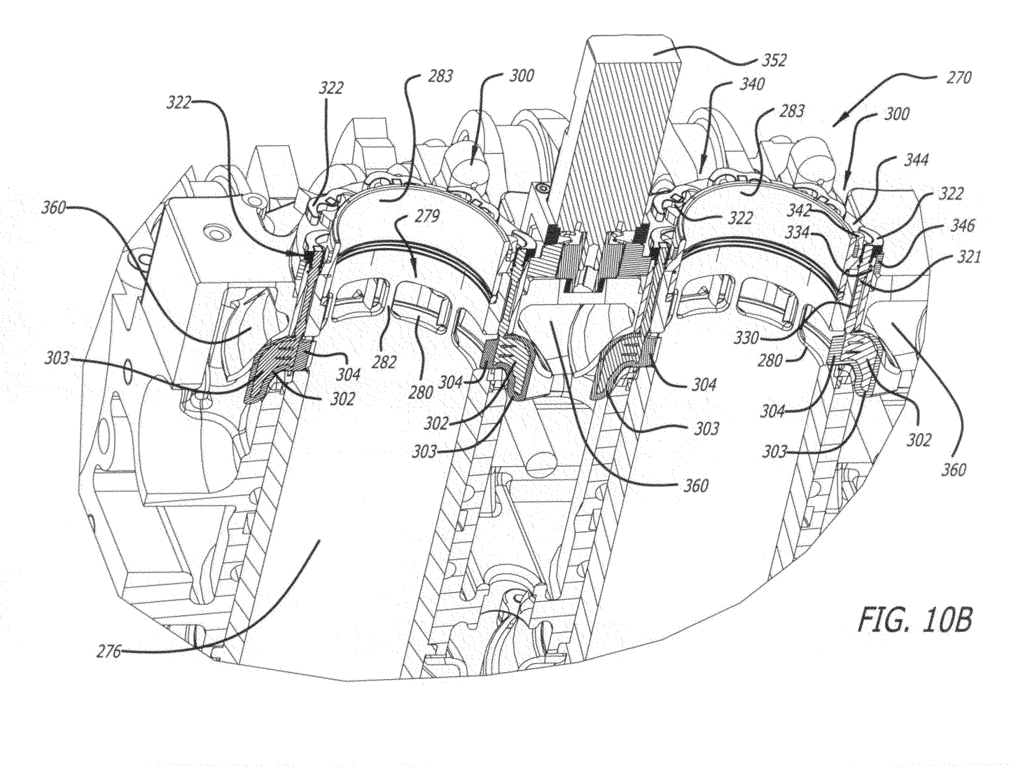

Third vane apparatus construction: A four-cylinder, ported engine of the opposed-piston type is shown in FIG. 9. The engine 270 is shown partially assembled, without connecting rod assemblies, in order to understand an alternate ported engine context. The engine 270 has two crankshafts 271 and four cylinder liners 276 disposed in a spar 277. The cylinder liners are aligned in a row, with intake ports on one side of the engine and exhaust ports on the other. The intake ports 279 (best seen in FIG. 10A) are positioned in an intake plenum 280 normally closed by a gallery cover (not seen). Charge air enters the intake plenum 280 through an intake aperture 278. Pressurized charge air flows from the intake plenum 280, through the intake ports 279 into the bores of the cylinder liners. A third vane apparatus construction 300 in the ported internal combustion engine 270 is operatively mounted to the intake port 279 of at least one cylinder 276 in order to vary the angle of charge air entering the intake port. The angular variability desirably enables the adjustment of in-cylinder swirl in response to changing engine operating conditions.

As best seen in FIGS. 10A and 10B, an intake port 279 is constituted of a ring of openings 280 interdigitated with bridges 282. An intake port 279 is located near the intake end 283 of a cylinder liner 276, slightly forward (toward TDC), of a BDC location of the piston associated with the intake port. The intake port 276 can be formed by machining, or during casting, of a cylinder liner.

With reference to FIGS. 10A and 10B, the engine 270 includes a third intake vane construction in operable engagement with the intake port 279 of each cylinder liner. The intake vane angling construction 300 includes a ring of moveable vanes 302 disposed around an intake port 279, with each vane 302 located adjacent to a respective one of the intake port openings 280; each vane 302 includes a blade 303 and a sealing lip 304. A vane drive assembly couples an actuator to the plurality of vanes. Through the vane drive assembly, the actuator varies the positions of the vanes in order to change the direction of scavenging air entering the intake port of a ported cylinder.

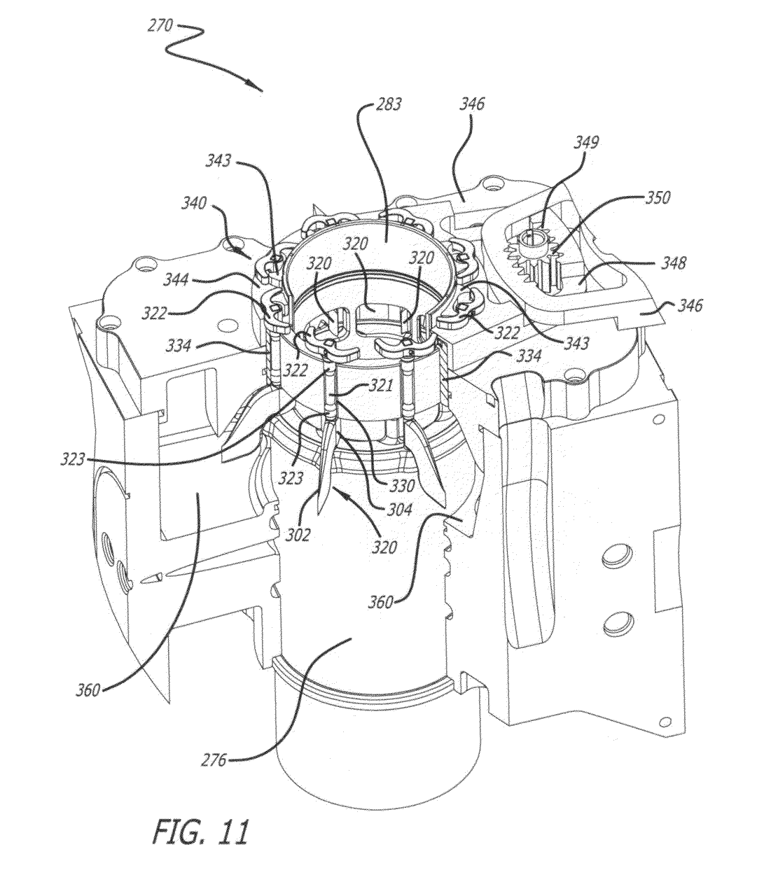

In the third vane apparatus, the vane drive assembly is cam-driven, and is embodied as a cam ring assembly mounted to an intake end of the ported cylinder liner, coaxially with the cylinder liner, and coupled to be oscillated on the axis of the cylinder liner by an actuator, such as a servo motor. The vanes are adapted for cam-driven actuation as illustrated in FIG. 11. In this embodiment, each vane 302 is part of a vane assembly 320 that also includes a shaft 321 and a cam rocker 322. The vane 302 is mounted to one end of the shaft 321, and the cam rocker 322 is mounted to the other end. The shaft 321 has longitudinally displaced circular bearing bands 323 to support rotation of the shaft.

As best seen in FIGS. 10B and 11, the shaft 321 of each vane assembly 300 is disposed in a longitudinal groove 330 running along the exterior surface of the intake end. The groove 330 is located so as to position the vane blade 303 in abutment with an intake port bridge 282 and adjacent an intake port opening 280 and to position the sealing lip 304 partially in an intake port opening 280. The groove 330 has a semi-circular cross section and the circular bearing bands 323 engage the groove so as to enable the shaft 321 to rotate in the groove 330. Rotation of the shaft 321 swings the blade 303 toward and away from the intake port opening 280. With the shafts disposed in the grooves as shown, each vane 302 is pivoted on a respective vane assembly axis having a spaced parallel relationship with the axis of the cylinder liner 276. With the shafts rotatably disposed in the grooves as shown, the cam rockers 322 are displaced radially outwardly from the cylinder liner 276, positioned between the intake port 279 and intake end 283.

FIGS. 10B and 11 show the cam-driven vane assembly shafts 321 retained in their rotatable positions in the longitudinal grooves 330 by a fixed ring 334 mounted at the intake end 283, coaxially with the cylinder liner 276. Preferably, the fixed ring 334 has longitudinal grooves (not seen) that cooperate with the longitudinal grooves 330 in the cylinder liner 276 to form circular tubes that rotatably retain the vane assembly shafts 321.

As per FIGS. 10B and 11 the cam ring assembly 340 includes an annular array of cams 342 mounted on a flange 344. A crescent shaped opening (not seen) is provided in the flange, radially spaced from each cam 342, to receive the upper end of a vane assembly shaft 321; a cam rocker 322 is attached to the upper end and positioned in a moveable engagement with a cam 342. The flange 344 is mounted to a drive ring 346 having a rear portion 348 with gear teeth 349 on an inside surface that engage a gear 350 driven by a computer-controlled actuator 352, such as a servo motor, seen in FIGS. 10A and 10B. As shown in FIGS. 10B and 11, the gear 350 can be coupled to operate two drive rings 346, thus enabling control of two variable intake vane angling apparatuses by one actuator. Of course this is not meant to so limit the scope of this construction, as a single drive ring 364 can be operated independently as may be desired for ported engines with multi-cylinder or single cylinder constructions.

Referring still to FIGS. 10B and 11, an actuator such as the servo motor 352 drives the gear 350 by rotating it incrementally in a clockwise or counter clockwise direction to rock a pair of drive rings 346, (one for each pair of cylinders). This rocking motion of a drive ring 346 causes the flange 344 to rotate clockwise or counterclockwise with a range of rotation predetermined and controlled by engine operation parameters. As the flange 344 moves, cam fingers 343 cause the cam rockers 322 to rotate, thus swinging the vanes 302 to a new angle. The sealing lips 304 swing with the blades 303 to cover more or less of a portion of the port bridge surfaces in order to guide air entry velocity vectors into the bore of the cylinder liner. Optionally, the intake gallery 280 can be contoured to provide a stationary intake bowl 360 fitted over the intake vane blades 303 of a variable intake vane angling device to form a ducted air passage channel guiding the intake air flow towards a swirl direction set by the vane blade angle. The profile of an intake bowl 360 can be shaped to match the vane blade rotational sweeping trajectory.

With reference to FIGS. 4, 10B, and 11, it is sometimes the case that localized air pressure imbalances can occur in an intake plenum, for example in the limited spaces between the lower wall and nearby intake port openings. Optionally, when the third vane apparatus is assembled to the intake ports, some vanes may be set to various predetermined initial positions different than the identical positions that are illustrated in the figures

Vane Apparatus Construction Considerations: The invention is not limited to an intake vane angling apparatus with a particular drive assembly construction. The vanes can be driven not only by ring and cam mechanisms, but also by gear sections and various types of linkages (similar to a VGT-type turbo). Furthermore, any individual vane can be actuated by electromechanical or even hydraulic mechanisms without the need for mechanical linkages or such. Additionally, a vane drive mechanism can be set up such that the rate of angular change is different between individual vanes thereby allowing compensation for flow imbalances inherent to the intake manifold design.

Vane Sizes and Numbers: The invention is not limited to any particular ratio in the size of vanes relative to the intake port openings. In this regard, each vane can be sized to cover substantially all of an intake port opening as per the third construction, or less than the entire port opening as per the first and second constructions. Further, the invention is not limited to any particular ratio in the number of vanes relative to the number of intake port openings. In this regard, the number of vanes can equal the number of intake port openings as per the first and third constructions, or can exceed the number of port openings as per the second construction, in which there are twice as many vanes as port openings. It is also desirable in some aspects that the number of vanes in an array be fewer than the number of openings in an intake Oft to which the array is mounted.

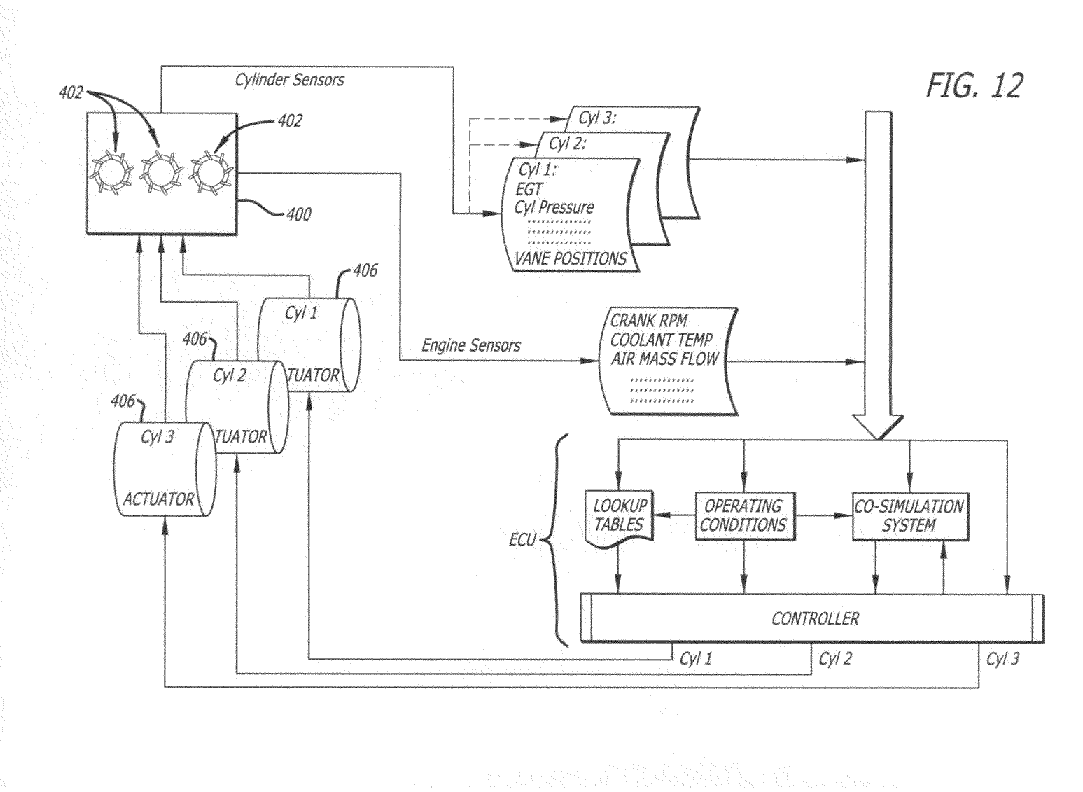

Swirl Control Mechanization: FIG. 12 is a flow diagram illustrating swirl control mechanization for a ported, two-stroke internal combustion engine 400 with one or more intake vane constructions, each mounted to a respective cylinder. For example, the engine 400 includes three ported cylinders 402, each equipped with an intake vane construction. The control mechanization controls at least one parameter of swirl in each cylinder 402 in response to engine operating conditions. For example, the control mechanization controls swirl angular velocity. Swirl control is implemented by an engine control unit (ECU) which receives information respecting engine operating conditions from a plurality of sensors (not shown). As an example, the flow diagram shows that cylinder sensors detect Exhaust Gas Temperature (EGT), cylinder (Cyl) pressure, and current vane positions for each intake vane construction while engine performance sensors detect such elements as crankshaft rpm, coolant temperatures, and air mass flow. All of the sensor information is sent to the ECU where real time analysis of operating conditions of the engine 400 are interpreted and compared with lookup table data to evaluate current engine performance with respect to engine operating parameters. This analyzed data is sent to a controller and, through feedback channels, to a co-simulation system within the ECU that simulates current engine performance data to determine a desired swirl for each cylinder. The co-simulation system then directs the controller to dynamically control one or more parameters of swirl inside each combustion chamber according to the engine load conditions. It is the output of the controller to each cylinder that determines what direction a computer-controlled actuator 406 will cause a vane drive assembly to change the vane blade angles so as to increase or decrease in-cylinder swirl.

Swirl Control Range: Based on modeling, empirical data, and/or other information about any particular ported engine construction equipped with intake vane apparatus to control swirl, a swirl control range can be established within which the positions of the vanes can be controlled by a control mechanization such as is illustrated in FIG. 12. The swirl control range is the range of angular positions to which one, some, or all of the vanes can be pivoted so as to control swirl in response to engine operating conditions. The elements of swirl control include at least the orientation of the intake port openings and current angular positions of the vanes. In this example, the swirl control portion attributable to the intake port openings is fixed; that attributable to the angular positions of the vanes is variable. The invention is not limited to a construction in which the slants of the intake openings are equal and the initial locations of the vanes are identical. Indeed, design and/or operating conditions of any particular construction may dictate variation in either or both of intake opening slant angle and intake vane initial position. Such variation can be useful, for example, to accommodate non-uniformity of charge air flow in an intake manifold.

Swirl Control Range Examples: In a useful aspect of the invention illustrated in the figures, a swirl control range is established by a fixed slant angle for all of the intake port openings 57, identical positioning of all vanes, and an angular range within which the vanes can be positioned. In the first construction, the angular range is a total arcuate distance in degrees from a first extreme position of the vanes shown in FIG. 3A to a second extreme position shown in FIG. 3C, with an intermediate or “base swirl” position shown in FIG. 3B. The intake opening slant angle corresponds to a base swirl condition that aggregates the individual airflows through all of the intake port openings. The base swirl condition relative to any intake port opening is composed of at least one air motion component that is directed radially toward the longitudinal center of the cylinder and at least one other air motion component that is directed tangentially relative to the longitudinal center of the cylinder. The angular position of each vane between the first and second extreme positions changes the magnitude of the radial component and the magnitude of the tangential component, which correspondingly changes the angular velocity of the swirl. Thus, for the example shown in FIGS. 3A-3C, the first extreme position of the vanes seen in FIG. 3A maximizes the influence of the tangential component of air motion into the cylinder with respect to its influence at the positions shown in FIGS. 3B and 3C. The angular velocity of the swirl is thereby maximized, producing a maximally intense swirl. Maximal swirl is useful, for example, under high engine load conditions to optimize both the mixture of charge air, recirculated exhaust gas, and fuel for good combustion and scavenging. As shown in FIG. 3B, the base swirl position of the vanes aligns them with the slants of the intake port openings to establish a base swirl condition that results in a less intense swirl than the maximal swirl. The base swirl condition is useful, for example, under constant speed, intermediate load conditions, with minimal or no EGR. In FIG. 3C, the angular position of the vanes relative to intake opening slant angle produces an angular component having a direction opposite the angular component of the intake vane slant angle, which reduces or eliminates swirl intensity.

For example, with reference to the first construction FIGS. 3A-3C show that the vanes 150 can to be swung to any angular position in an arc of 80°, in which the portion of the arc between the angular positions of FIGS. 3A and 3B is 50°, and the portion between the positions of FIGS. 3B and 3C is 30°, thereby enabling continuous variation of the angle at which pressurized air enters the cylinder and continuous variation of the angular velocity of swirl. As is evident from FIGS. 6A-6C (and FIG. 11), each of the vanes 250 of the second construction (and the third construction) can be swung to any angular position in an arc of 180° such that the intake openings are closed when the vanes are at 0° and 180° and airflow into the cylinder is cut off. At vane positions of 90°, the charge air flows through the ports in a substantially radial direction, producing little or no swirl. Between the 0° and 90° positions of the vanes, swirl of varying intensity in a first circulation direction is produced; between the 90° and 180° positions of the vanes, swirl of varying intensity in a second circulation direction is produced.

Although the description and figures of this specification are directed to certain preferred embodiments, it should be evident that an intake vane apparatus as described and illustrated in this document may be otherwise constructed and still be within the scope of the following claims.

1. A ported cylinder for an internal combustion engine and a vane apparatus to control the direction of air entering an intake port in the sidewall of the cylinder in response to an actuator, the vane apparatus including a ring of moveable vanes retained on the cylinder, abutting the intake port, each vane disposed adjacent an intake port opening to be swung toward and away from the intake port opening on an axis having a spaced parallel relationship with the axis of the cylinder, and a vane drive assembly coupling the actuator to the ring of vanes.

2. The ported cylinder and vane apparatus of claim 1, wherein a slot is formed in each vane and the vane drive assembly includes an actuating ring disposed on an outside surface of the cylinder to be rotated thereon in opposing circumferential directions of the cylinder, and pins on the actuating ring drivingly engaged in the slots of the vanes.

3. The ported cylinder and vane apparatus of claim 2, wherein the intake port includes a number of port openings in the sidewall and the ring of moveable vanes includes a number of vanes equal to the number of port openings.

4. The ported cylinder and vane apparatus of claim 2, wherein the intake port includes a number of port openings in the sidewall and the ring of moveable vanes includes a number of vanes greater than the number of port openings.

5. The ported cylinder and vane apparatus of claim 2, wherein each vane is pivotally retained in abutment with a respective bridge of the intake port.

6. The ported cylinder and vane apparatus of claim 2, wherein each vane is pivotally retained in a groove on a respective bridge of the intake port.

7. The ported cylinder and vane apparatus of claim 1, wherein the vane drive assembly includes a cam ring assembly coupled to be rotatably oscillated by the actuator and an annular array of cams on the cam ring assembly, each cam moveably engaging a respective vane.

8. The ported cylinder and vane apparatus of claim 7, wherein each vane includes a pivot shaft mounted in a longitudinal groove running along an exterior surface of a port bridge of the intake port, the vane being mounted to one end of the pivot shaft, and a cam follower mounted to an opposite end of the pivot shaft.

9. The ported cylinder and vane apparatus of claim 8, further including a fixed ring mounted on the cylinder to retain the pivot shafts in the longitudinal grooves.

10. The ported cylinder and vane apparatus of claim 9, wherein the cam ring assembly includes a moveable ring with a central collar around the periphery of the intake end and carrying the annular array of cams in operable engagement with the cam followers.

11. The ported cylinder and vane apparatus of claim 10, each vane including a major vane portion extending from the pivot shaft to which the vane is mounted and outwardly of the intake port opening to which it is adjacent, and a minor vane portion extending from the pivot shaft to which the vane is mounted and inwardly of the intake port opening to which it is adjacent.

12. The ported cylinder and vane apparatus of claim 1, in which the intake port includes at least one ring of intake port openings interdigitated with bridges, and the intake port openings are oriented either in a tangential direction or a radial direction relative to the cylinder.

13. A intake vane combination for controlling a swirl component of charge air in a ported internal combustion engine, the intake vane combination including a cylinder with an intake port operable to conduct charge air into the bore of the cylinder, a ring of pivoted vanes, each pivoted vane disposed adjacent an intake port opening and moveable toward and away from the intake port opening so as to change an angle at which charge air is deflected through the intake port opening, a vane drive assembly for coupling an actuator to the ring of pivoted vanes, in which each pivoted vane has a slot and the vane drive assembly includes an actuating ring disposed on an outside surface of the cylinder to be rotated thereon in opposing circumferential directions of the cylinder and pins on the actuating ring drivingly engaged in the slots of the vanes

14. A intake vane combination for controlling a swirl component of charge air in a ported internal combustion engine, the intake vane combination including a cylinder with an intake port operable to conduct charge air into the bore of the cylinder, a ring of moveable vanes, each disposed adjacent an intake port opening and moveable toward and away from the intake port opening so as to change an angle at which charge air is conducted through the intake port opening, a cam ring assembly mounted to an intake end of the cylinder near the intake port, an annular array of cams on the cam ring assembly, each cam coupled to move a respective vane, and an actuator coupled to the cam ring assembly for oscillating the annular array of cams on the axis of the cylinder.

15. A method of operating an intake vane apparatus in a ported internal combustion engine in order to control swirl of charge air in a cylinder, the method including engaging a ring of vanes surrounding an intake port of the cylinder with a vane drive assembly coupling an actuator to the ring of pivoted vanes, conducting intake air into the bore of the cylinder through the intake port in the cylinder, operating the actuator to rotate the vane drive assembly, the vane drive assembly rotation causing each vane to move toward or away from the intake port so as to change an angle at which the intake air is conducted through openings of the intake port.

16. A ported internal-combustion engine including at least one cylinder with an intake port having a plurality of openings oriented to guide air into the cylinder and an annular array of intake vanes positioned in an abutting relationship with the intake port, in which an actuator is disposed in actuating contact with the array of intake vanes to pivot each intake vane through an arc adjacent at least one of the openings.

17. The ported internal-combustion engine of claim 16, in which the arc is substantially 100°.

18. The ported internal-combustion engine of claim 16, in which the arc is substantially 180°.

19. The ported internal-combustion engine of claim 16, in which the actuator is disposed in actuating contact with the array of vanes to continuously pivot each vane bi-directionally.

20. A method of operating a ported, two-stroke internal-combustion engine including at least one cylinder with a sidewall, an intake port in the sidewall having a plurality of openings to guide charge air into the cylinder, and an annular array of vanes positioned on respective pivot axes near the intake port, by swinging the vanes relative to the openings such that an angle at which the charge air enters the intake port changes with an angle of the vanes relative to the openings.

21. The method of operating a ported, two-stroke internal-combustion engine of claim 20, in which the vanes are swung in response to an engine operating parameter.

22. The method of operating a ported, two-stroke internal-combustion engine of claim 21, in which the engine operating parameter includes at least one of exhaust gas temperature, cylinder pressure, and current vane positions.

23. The method of operating a ported, two-stroke internal-combustion engine of claim 22, in which the engine operating parameter further includes at least one of crankshaft rpm, coolant temperatures, and air mass flow.

24. The method of operating a ported, two-stroke internal-combustion engine of claim 21, in which the engine operating parameter includes at least one of crankshaft rpm, coolant temperatures, and air mass flow

25. The method of operating a ported, two-stroke internal-combustion engine of claim 21, in which swinging the vanes includes swinging the vanes to a position in a swirl control range of at least 100°.

26. A method of operating a uniflow, two-stroke, opposed-piston engine including at least one cylinder with a sidewall and a bore, an exhaust port in the sidewall, and an intake port in the sidewall having a plurality of openings through which charge air enters the bore, and a pair of opposed pistons disposed in the bore, by causing charge air entering the bore through the intake port openings to swirl in the bore, measuring an engine operating parameter, adjusting the charge air swirl in response to the measured engine operating parameter, compressing the adjusted swirling charge air between the pistons, and injecting fuel into the compressed charge air.

27. The method of operating a ported, two-stroke, opposed-piston engine of claim 26, in which a plurality of pivoted vanes are disposed adjacent the intake port, and adjusting the charge air swirl includes adjusting an angular position of the vanes in response to the engine operating parameter.

28. The method of operating a ported, two-stroke, opposed-piston engine of claim 27, in which the engine operating parameter includes at least one of exhaust gas temperature, cylinder pressure, and current vane positions.

29. The method of operating a ported, two-stroke, opposed-piston engine of claim 28, in which the engine operating parameter further includes at least one of crankshaft rpm, coolant temperatures, and air mass flow.

30. The method of operating a ported, two-stroke, opposed-piston engine of claim 27, in which the engine operating parameter includes at least one or more of crankshaft rpm, coolant temperatures, and air mass flow

31. The method of operating a ported, two-stroke, opposed-piston engine of claim 27, in which the angular position is within an arc of at least 80°.
